(19) United States
(12) Patent Application Publication
(10) Pub. No.: US 2005/0098053 A1
(43) Pub. Date: May 12, 2005

(54) Device for attaching a roller to an abutment moving essentially at the peripheral speed of the roller by means of a spindle-nut combination

(76) Inventors: Dietmar Koopmann, Lienen (DE); Robert Blom, Tecklenburg (DE); Guenter Rogge, Lienen (DE)

Correspondence Address: JACOBSON HOLMAN PLLC, 400 SEVENTH STREET N.W., SUITE 600, WASHINGTON, DC, 20004, US

(21) Appl. No.: 10/502,652

(22) PCT Filed: Mar. 10, 2003
(86) PCT No.: PCT/EP03/02451

(30) Foreign Application Priority Data
Mar. 14, 2002 (DE) 102 11 328.9

(51) Int. Cl. B41F 13/24

(52) U.S. Cl. 101/247

(57) ABSTRACT

For applying a roller to a counterbearing moved essentially at the circumferential speed of the roller, [sic] consists of a spindle-nut combination. In order to be able to adjust the play of the spindle in a simple manner, an additional nut is associated with, and displaceable against the spindle nut. Both nuts mesh with the thread of the spindle. An additional securable nut is provided.

The invention relates to a device for applying a roller, by means of a spindle-nut combination, to a counterbearing moved essentially at the circumferential speed of the roller, preferably for applying a print roller or anilox roller to the central impression cylinder of a flexographic printing press.

A spindle screwed into the spindle nut customarily has, between the threads, a certain play, which, over time, can increase in an undesired manner. For example, in the case of flexographic printing presses (DE 29 41 521 A1, DE 34 37 216 C2, DE 37 42 129 A1, DE 40 01 735 A1), the bearing blocks, which can be traversed in the guides of brackets of the printing press frame, are moved by spindle drives to apply the print roller to, and to withdraw it from, the impression roller. Since the print rollers have to be applied very delicately to the print substrate running over the impression roller, increasing play of the spindles can have a disadvantageous effect on the quality of the printing.

It is thus the objective of the invention to provide a device of the type specified initially whose play can be adjusted so that it is possible to avoid exchanging the spindle or spindle nut when play increases.

According to the invention this objective is realized by the features of claim 1.

Advantageous developments of the invention are the object of claims 2 to 4.

According to a preferred form of embodiment, it is provided that the spindle nut is provided with a hole section with an inner thread, the diameter of said hole section being expanded, into which thread an adjusting ring is screwed by its outer thread, that the adjusting ring has an inner thread which conforms to a part of the thread of the spindle nut, and that the adjusting ring comprises apparatus for turning and a turning constraint for its fixation. The spindle according to the invention is distinguished by the fact that the thread of the spindle nut consists of two sections which are displaceable in the axial direction relative to one another so that thereby a desired play can be reduced in the intended manner. Due to the fact that according to the invention the play of the spindle in the spindle nut can be reduced, the lifetime of the spindle can be increased significantly.

In an expedient manner the apparatus for turning consists of a radial hole of the adjusting ring. Into this hole, which can be a blind hole, a pin can be inserted and, via this, the adjusting ring can be turned by a suitable angle for the reduction of the play. In order to make this radial hole accessible in a simple manner, it can be reachable through a slot, running in the circumferential direction, in the spindle nut.

After the adjustment of the adjusting ring, it is to be secured in its position. As a constraint against unintended turning, a securing ring provided with an outer thread can be provided, where said securing ring can be screwed into the spindle nut and braced against the adjusting ring. In order to also be able to turn the securing ring to brace it against the adjusting ring, it can be provided with two axially directed holes.

In an expedient manner the spindle nut is provided with a radial hole for the supply of lubricant. This not only reduces the wear but also serves to reduce the play. In an expedient manner the lubricant hole empties at the boundary of the expanded hole section of the spindle nut.

An embodiment example of the invention will be explained in more detail in the following with the aid of the drawings. Shown in these are:

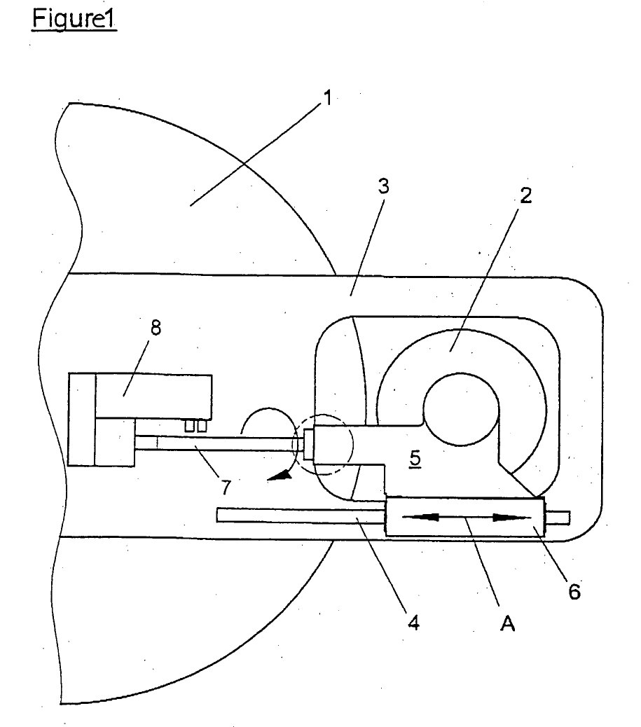

FIG. 1 a lateral view, in schematic representation, of a flexographic printing press's print roller which can be applied to the impression roller;

FIG. 2 a longitudinal section through an encircled part in FIG. 1, said part showing a spindle nut with spindle screwed in;

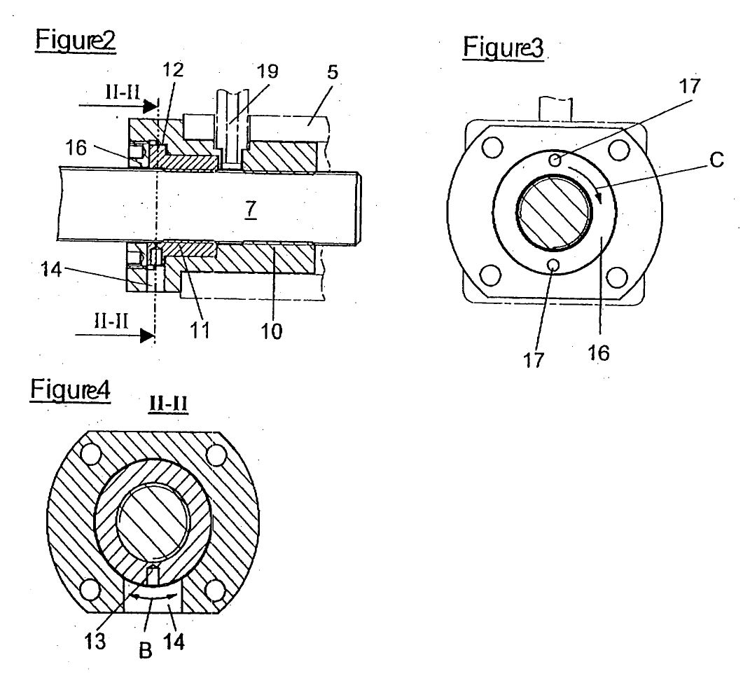

FIG. 3 a frontal view of the spindle nut; and

FIG. 4 a section through the spindle nut along the line [sic] I-I in FIG. 2.

From FIG. 1 a central impression cylinder 1 can be seen which is mounted in the customary manner in a printing pressing frame not represented. The printing pressing frame is provided with two laterally projecting side frames 3 of a printing device bracket which are each provided with guide rails 4 in which carriages 6, carrying bearing blocks 5, are guided in the direction of the double arrow A in such a manner that they can be displaced. In the bearing blocks 5 a print roller 2 is mounted in the customary manner. The drives of the central impression cylinder 1 and the print cylinder 2 are of the customary type and thus not represented.

In order to apply the print roller 2 to, and withdraw it from, the central compression cylinder 1, spindle drives are provided, where each spindle 7 can be driven by a drive motor 8 which is connected to the printing press frame or to each of the side frames 3. In the embodiment example represented, the spindle 7 is driven by the drive motor 8, but is axially immovable relative to it.

With the aid of FIGS. 2 to 4 the spindle nut, which is enclosed in FIG. 1 by a dotted circle, will be described in more detail.

In a hole of each of the bearing blocks 5, which is sufficiently deep or penetrating, a spindle nut 10 is inserted, in such a manner that it cannot be turned, and the spindle 7 is screwed into this spindle nut. The spindle nut 10 has on its left side in FIG. 2 an expanded hole section into which an adjusting ring 11 is screwed. This adjusting ring is provided with an inner thread which is formed basically in the same manner as the inner thread of the spindle nut 10. The adjusting ring 11 is provided with a widened edge section 12 which lies in an additional hole section of the spindle nut 10, said hole section being widened via an annular step. This widened [sic] hole section 12 is provided with a blind hole 13 which lies in a slot 14 of the spindle nut 10, said slot running in the circumferential direction. Through the slot 14 a pin can be inserted into the blind hole 13 by which pin the adjusting ring 11 can be turned in the direction of the double arrow B in FIG. 4. Through appropriate turning, the adjusting ring 11 is turned, via its outer thread, in the inner thread of the expanded hole section so that it experiences a slight axial movement.

Into the inner thread of the outer hole section, once again expanded via an annular step, of the spindle nut 10, a securing ring 16 is screwed which is provided on its frontal side with two blind holes 17 lying opposite one another. Into these blind holes 17 the spikes of a suitable tool can be inserted so that the securing ring 16 can be turned in the direction of the arrow C and braced against the adjusting ring 11 to secure against its undesired turning.

The bearing block 5, as well as the spindle nut 10, is provided with a radial hole into which a line 19 for the supply of lubricant empties.

1. Device for applying a roller, by means of a spindle-nut combination, to a counterbearing moved essentially at the circumferential speed of the roller, preferably for applying a print roller or anilox roller to the central impression cylinder of a flexographic printing press, characterized in that
an additional nut is associated with, and displaceable against, the spindle nut (10), where both nuts mesh with the thread of the spindle, and that the additional nut can be secured.

2. Device according to claim 1, characterized in that the additional nut formed as an adjusting ring (11) is associated with a securing ring (16) for securing.

3. Device according to claim 1, characterized in that the securing ring (16) has an outer thread which conforms to the inner thread of a holder which is immovable with respect to the spindle nut (10).

4. Device according to claim 3, characterized in that the holder is a part of the spindle nut (10).

5. Device according to claim 1, preferably a spindle to apply a print roller (2) to, and to withdraw it from, an impression roller (1) of a printing press with a spindle nut (10),
characterized in that
the spindle nut (10) is provided with a hole section with an inner thread, the diameter of said hole section being expanded, into which thread an adjusting ring (11) is screwed by its outer thread,
that the adjusting ring (11) has an inner thread which conforms to a part of the thread of the spindle nut (10), and
that the adjusting ring (11) comprises an apparatus for turning and a turning constraint for its fixation.

6. Device according to claim 5, characterized in that the apparatus for turning consists of a radial hole (13) of the adjusting ring (11).

7. Device according to claim 6, characterized in that the radial hole (13) is accessible through a slot (14), running in the circumferential direction, in the spindle nut (10).

8. Device according to claim 5, characterized by the fact that, as a constraint against unintended turning, a securing ring (16) with an outer thread is provided, where said securing ring can be screwed into the spindle nut (10) and braced against the adjusting ring (11).

9. Device according to claim 5, characterized by the fact that the securing ring (16) is provided on its frontal side with two axially directed blind holes (17).

10. Device according to claim 5, characterized by the fact that the spindle nut (10) is provided with a radial hole for the supply of lubricant.

11. Device according to claim 10, characterized by the fact that the lubricant hole empties at the boundary of the expanded hole section of the spindle nut (10).
